(19) United States
(12) Patent Application Publication
(10) Pub. No.: US 2025/0234330 A1
(43) Pub. Date: Jul. 17, 2025

(54) WIFI RANGING

(71) Applicant: NXP USA, Inc., AUSTIN, TX (US)

(72) Inventors: Niranjan Grandhe, Fremont, CA (US); Christian Raimund Berger, San Jose, CA (US)

(21) Appl. No.: 18/965,616

(22) Filed: Dec. 2, 2024

Related U.S. Application Data
(60) Provisional application No. 63/621,911, filed on Jan. 17, 2024.

(51) Int. Cl. H04W 64/00; H04W 24/08

(52) U.S. Cl. CPC H04W 64/006; H04W 24/08

(57) ABSTRACT

One example discloses a first wireless communication device, including: a transceiver configured to be coupled to an antenna; a controller coupled to the transceiver; wherein the controller is configured to calculate a range to a second wireless communication device based on a set of exchanged messages; wherein the controller is configured to calculate the range while limiting at least one of: a set of allowed message repetitions and a set of allowed LTF (long training frame) totals, for channel bandwidths (BW) greater than 160 MHz.

### REFERENCE TO PROVISIONAL APPLICATION TO CLAIM PRIORITY

A priority date for this present U.S. patent application has been established by prior U.S. Provisional Patent Application, Ser. No. 63/621,911, entitled “11BK 320 MHZ Ranging Capabilities”, filed on Jan. 17, 2024, and commonly assigned to NXP USA, Inc.

The present specification relates to systems, methods, apparatuses, devices, articles of manufacture and instructions for wireless ranging.

### SUMMARY

According to an example embodiment, a first wireless communication device, comprising: a transceiver configured to be coupled to an antenna; a controller coupled to the transceiver; wherein the controller is configured to calculate a range to a second wireless communication device based on a set of exchanged messages; wherein the controller is configured to calculate the range while limiting at least one of: a set of allowed message repetitions and a set of allowed LTF (long training frame) totals, for channel bandwidths (BW) greater than 160 MHz.

In another example embodiment, the channel bandwidth is less than or equal to 320 MHz.

In another example embodiment, the controller is configured to calculate the range while limiting both the set of allowed message repetitions and the set of allowed LTF (long training frame) totals, for channel bandwidths (BW) greater than 160 MHz.

In another example embodiment, the controller is configured to calculate the range using a time of flight (TOF) of a message transmitted from the first wireless communication device to the second wireless communication device.

In another example embodiment, the controller is configured to calculate the range using a first time of flight (TOF) of a first message transmitted from the first wireless communication device to the second wireless communication device, and using a second time of flight (TOF) of a second message transmitted from the second wireless communication device to the first wireless communication device.

In another example embodiment, the first device is a station (STA) and the second device is an access point (AP); the STA calculates its range to the AP as, range=c*TOF; c is a speed of light in a vacuum or air; TOF (Time Of Flight)=[(t4−t1)−(t3−t2)]/2; t1=TOD (Time Of Departure) of a first message (M1) transmitted from the STA to the AP; t2=TOA (Time OF Arrival) of the first message (M1) received by the AP; t3=TOD of a second message (M2) transmitted from the AP to the STA; and t4=TOA of the second message (M2) received by the STA.

In another example embodiment, the calculate the range is non-trigger-based; and the set of messages exchanged between the first device and the second device include: a Measurement Sounding part, that performs two-way exchange of Null Data frames to acquire a channel impulse response; and a Reporting part, that exchanges encrypted TOF (Time Of Flight) estimations.

In another example embodiment, the calculate the range is trigger-based; the first device is part of a set of devices assigned to the second device; and the set of messages exchanged between the first device and the second device include: a Polling part, that performs a fast poll among the set of assigned devices to identify short term resource needs; a Position (FTM) Sounding part, that performs a two-way exchange of Null Data frames to acquire a channel impulse response; and a Reporting part, that exchanges encrypted TOF (Time Of Flight) estimations.

In another example embodiment, the set of messages include a format and bandwidth subfield that indicates a requested or allocated PPDU format and a bandwidth (BW) used to transmit the messages.

In another example embodiment, the format and bandwidth subfield includes capability bits that specify support for 160 MHz operation and support for 320 MHz operation.

In another example embodiment, the first device is an Initiating STA (ISTA) and the second device is a Responding STA (RSTA); and the range is an I2R/R2I (ISTA to RSTA/RSTA to ISTA) range.

In another example embodiment, the set of messages include a format and bandwidth subfield that includes capability bits that specify, a Max R2I STS (a maximum number of space-time streams (STS) to be used in R2I NDP in a session); and a Max I2R STS (a maximum number of space-time streams to be used in I2R NDP in a session).

In another example embodiment, the format and bandwidth subfield includes capability bits that specify a Max I2R LTF Total, a Max R2I LTF Total, a Max I2R Repetition, and a Max R2I Repetition for BW<=160 MHz.

In another example embodiment, the set of messages include a subelement that includes a Max I2R Repetition=320 MHz subfield set to a maximum number of EHT-LTF repetitions that the ISTA uses in a preamble of 320 MHz I2R NDP.

In another example embodiment, the Max I2R Repetition=320 MHz subfield is set to a number of EHT-LTF repetitions minus 1.

In another example embodiment, the set of messages include a subelement that includes a Max R2I Repetition=320 MHz subfield set to a maximum number of EHT-LTF repetitions that the RSTA uses in the preamble of 320 MHz R2I NDP.

In another example embodiment, the Max R2I Repetition=320 MHz subfield is set to a number of EHT-LTF repetitions minus 1.

In another example embodiment, the set of messages include a subelement that includes a Max R2I LTF Total=320 MHz that indicates a maximum number of EHT-LTFs to be destined to an ISTA in the 320 MHz R2I NDP.

In another example embodiment, the set of messages include a subelement that includes a Max I2R LTF Total=320 MHz subfields that indicates a maximum number of EHT-LTFs to be destined to an RSTA in an 320 MHz I2R NDP.

In another example embodiment, the first and second messages advertise or list an I2R/R2I repetition capability for BW=320 MHz and BW<=160 MHz separately.

In another example embodiment, first and second messages advertise or list an I2R/R2I LTF total capability for BW=320 MHz and BW<=160 MHz separately.

In another example embodiment, the I2R/R2I repetition capability and the I2R/R2I LTF total capability are advertised or listed in a subelement of the messages.

In another example embodiment, the first and second messages conform to wireless LAN medium access control (MAC) and physical layer (PHY) protocols for WiFi communications.

According to an example embodiment, a method for wireless ranging, comprising: calculating a range from a first wireless communication device to a second wireless communication device; calculating the range while limiting a set of allowed message repetitions for channel bandwidths (BW) greater than 160 MHz; and calculating the range while limiting a set of allowed LTF (long training frame) totals, for channel bandwidths (BW) greater than 160 MHz.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents an example WiFi ranging measurement.

FIG. 2 represents an example of MIMO based WiFi ranging.

FIG. 3 represents an example of a WiFi ranging frame.

FIG. 4 represents an example of a ranging subelement in the WiFi ranging frame.

FIG. 5 represents an example set of additional fields to be included in the ranging subelement in the WiFi ranging frame.

FIG. 6 represents an example system for hosting instructions for enabling a WiFi ranging measurement apparatus.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

Smartphones have enabled users to benefit from many location based services. For example GPS has enabled such users to navigate on highways and reach a building of their choice. However, upon entering such buildings GPS signals are almost always blocked by the building's structures.

Wi-Fi has stepped into this void and provides an opportunity for smartphone users to have spatial awareness inside of buildings. Additionally, building tenants can benefit from this spatial awareness of smartphone users (e.g. customers) to provide additional services.

Such indoor spatial awareness services in public domain applications may include: finding your way to a product; in store analytics (e.g. locating a product in the store), and customer flow. Enterprise applications may include: tracking products on shelves and/or in a warehouse or stock room, user analytics (e.g. serving an advertisement to a customer), location as a service, indoor navigation, smart office services, and asset tracking/smart warehouse. Proximity applications may include: share photos with nearby devices, IoT control of a device (e.g. turn on the lamp). Secure Access applications may include: ticketing, unlock/lock a laptop PC, a smartphone screen, and a door (e.g. to a car or a venue).

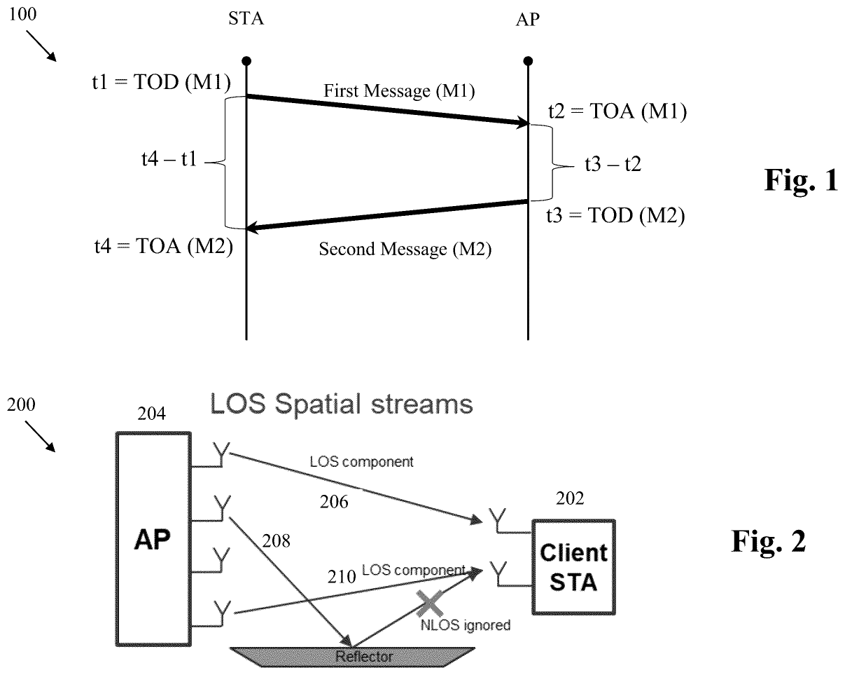

FIG. 1 represents an example 100 WiFi ranging measurement. The example 100 includes a first wireless communication device (e.g. STA (station/client)), a second wireless communication device (e.g. AP (access point/host)), a first message and a second message. In this example embodiment, the first and second messages conform to wireless LAN medium access control (MAC) and physical layer (PHY) protocols for WiFi communications.

In this example 100, the first device (STA) calculates its range to the second wireless communication device (AP) using a TOF (Time Of Flight) protocol. TOF measures range between an Initiating STA (ISTA) (e.g. the first wireless communication device (STA) and a Responding STA (RSTA) (e.g. the second wireless communication device (AP), collectively referred to as I2R (ISTA to RSTA) range. Note, for the discussion that follows R2I refers to an RSTA to ISTA range.

Where: t1=TOD (Time Of Departure) of the first message (M1) from the STA to the AP; t2=TOA (Time OF Arrival) of the first message (M1) at the AP; t3=TOD of the second message (M2) from the AP to the STA; t4=TOA of the second message (M2) at the STA; and TOF=[(t4−t1)−(t3−t2)]/2.

The I2R range is equal to the TOF multiplied by a Speed Of Light (c) in vacuum/air. That is I2R range=c*TOF.

TOD is measured using a fine granularity counter, calibrated to the transmit chain, and TOA is estimated using a combination of fine granularity counter with an algorithm to extract the first path signal arrival.

While WiFi based TOF requires wideband technology, it is mostly unaffected by changes to signal strength (e.g. path loss, antenna pattern, fast fading) and thus is a sophisticated approach to I2R range measurement. In various example embodiments, TOA is extracted from the message's (M1, M2) HE LTF field channel response.

FIG. 2 represents an example 200 of MIMO (Multiple-Input Multiple-Output) based WiFi ranging. The example 200 includes a first wireless communication device 202 (e.g. STA (station/client)), a second wireless communication device 204 (e.g. AP (access point/host)), a first message 206, a second message 208, and a third message 210. In this example embodiment, the three messages conform to wireless LAN medium access control (MAC) and physical layer (PHY) protocols for WiFi communications. The first and second wireless communication devices 202, 204 also include necessary antennas, transceivers, and controllers not specifically shown.

Due to the spatial diversity since the STA 202 and AP 204 have multiple antennas (i.e. is MIMO), an I2R range between the STA 202 and AP 204 can be much more accurate and robust. Such MIMO TOF (Time Of Flight) measurements can be made using either transmit messages, receive messages, or both. This enables greater location accuracy (i.e. a STA can measure against many APs; many STAs can measure against many APs; many STAs can use regular data connection without slow down, and MIMO provides spatial diversity at no increase to medium use. Ranging using a single TXOP means shorter medium time per measurement instance, and Wi-Fi waveforms enable larger number of samples per measurement (sounding) frame.

I2R ranging using WiFi can be either non-trigger-based (non-TB) or trigger-based (TB).

For non-trigger-based ranging operations, the exchanged messages (M1, M2) include: a Measurement Sounding part, that performs two-way exchange of Null Data frames to acquire the channel impulse response; and a Reporting part, that exchanges encrypted TOF estimations.

Pros/Cons of non-trigger-based ranging include: unscheduled operations; AP always ready; shorter Rx channel time; ad-hoc decisions to avoid scheduling conflicts and adapt to measurement rate; simple Request/Assignment negotiation (FTM Req/Rsp); adapts Wi-Fi channel sounding to TOF; and measurement exchange is triggered by NDPA (UL) sent by ISTA.

For trigger-based ranging operations, the exchanged messages (M1, M2) include: a Polling part, that performs a fast poll among assigned STAs to identify short term resource needs; a Measurement Sounding part, that performs two-way exchange of Null Data frames to acquire the channel impulse response; and a Reporting part, that exchanges encrypted TOF estimations.

Pros/Cons of trigger-based (TB) ranging include: scheduled operation; client STAs assigned to known time windows; client STAs pick and choose scheduling that aligns with their data connections; TB operation makes use of UL Multi User MIMO and DL MU MIMO, however, DL-MU MIMO is only for the measurement reporting part while the sounding part still uses DL-SU NDP; in the UL users are multiplexed to different spatial streams; and in the DL users receive a multicast transmission from a single AP.

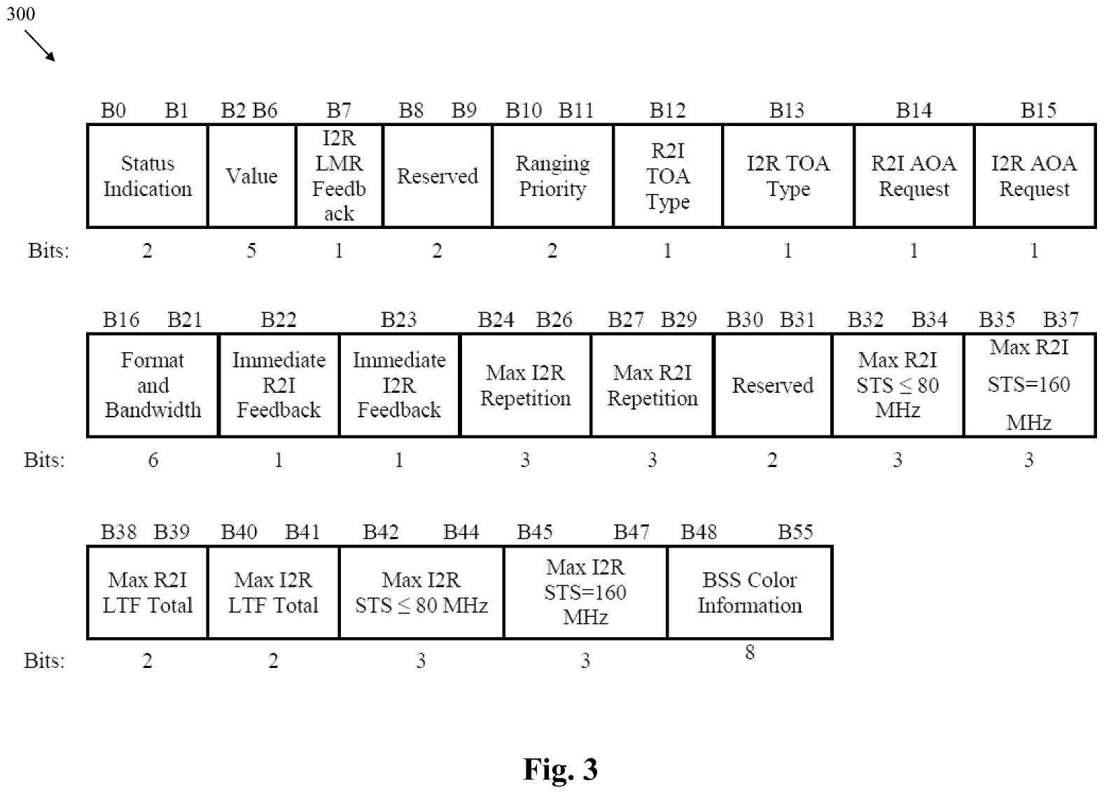

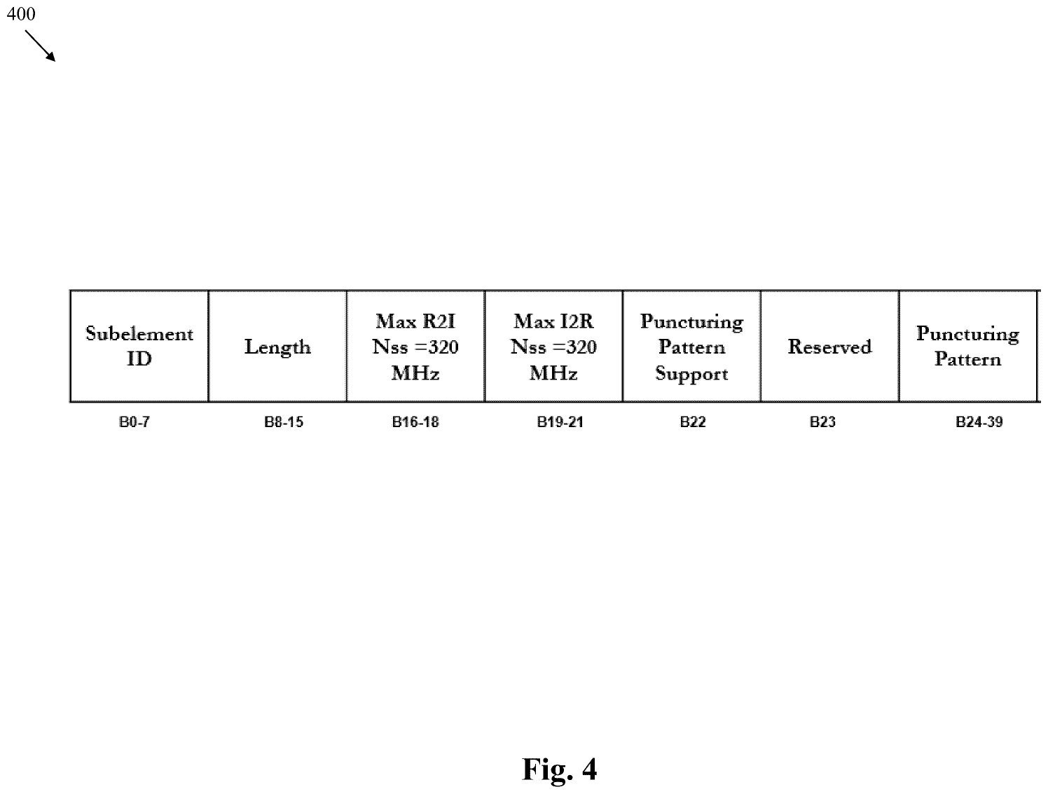

FIG. 3 represents an example 300 of a WiFi ranging frame. The example ranging frame 300 is embedded within various messages exchanged between the first and second wireless communication devices (STA, AP). The example ranging frame 300 shows a ranging parameters field format for a ranging parameters element in a WiFi ranging management and extension frame.

In this example 300, a format and bandwidth subfield within the frame indicates a requested or allocated PPDU format and bandwidth used to transmit the I2R/R2I NDP exchange as part of the non-trigger-based (non-TB) ranging, or trigger-based (TB) ranging measurement exchange.

The format and bandwidth subfield capability bits (i.e. values) specify: STA support for 160 MHz operation as either 80+80, 160 two-LO or 160 single-LO respectively in addition to supporting 80, 40 and 20 MHz bandwidths; and STA support for 320 MHz operation as 320 MHz single-LO using EHT format in addition to supporting 160 single-LO, 80, 40 and 20 MHz bandwidths in HE format.

A Max R2I STS=160 MHz subfield indicates for the bandwidths of 160 MHz the maximum number of space-time streams (STS) to be used in R2I NDP in the session. A Max I2R STS=160 MHz subfield indicates for the bandwidths of 160 MHz the maximum number of space-time streams to be used in I2R NDP in the session. A Transmit Power Envelope subelement is also shown.

Capability bits for Max I2R LTF Total, Max R2I LTF Total, Max I2R Repetition, Max R2I Repetition for BW<=160 MHz are also shown.

FIG. 4 represents an example 400 of a ranging subelement in the WiFi ranging frame 300. The example ranging subelement 400 is also embedded within the various messages exchanged between the first and second wireless communication devices (STA, AP).

As shown in FIG. 4, the format for a set of subelement fields includes: a Subelement ID (capability bits B0-7) and Length field (bits B8-15); a Max R2I Nss=320 MHz field (bits B16-18) that indicates for bandwidths up to 320 MHz, a maximum number of spatial streams (Nss) to be used in R2I NDP in the session; a Max I2R Nss=320 MHz field (bits B19-21) that indicates for a bandwidth of 320 MHz a maximum number of spatial streams to be used in I2R NDP in the session; a Puncturing Pattern Support field (bit B22) set to one to indicate support of all valid puncturing patterns, and it is set to zero to indicate support of only the subset of puncturing patterns; a Puncturing Pattern field (bits B24-39) used by the RSTA to convey a Disabled Subchannel Bitmap to the ISTA in the IFTM frame. It is reserved when included in the IFTMR frame by the ISTA.

All the I2R Rep subfields in the User Info fields of the TF Ranging Sounding are set to a same value. This same value indicates a number of LTF repetitions in the I2R NDP preamble and shall not exceed any of the RSTA Assigned I2R Rep corresponding to the ISTA triggered by this Trigger frame.

A product of the number of LTF repetitions, indicated in each of the I2R Rep subfields of the User Info fields, and a number of HE-LTF symbols, indicated in the Number Of HE-LTF Symbols And Midamble Periodicity subfield in the Common Info field, does not exceed the RSTA Assigned I2R LTF Total for any of the ISTA triggered by this Trigger frame.

A number of LTF repetitions in the R2I Rep subfield is set to a value not to exceed the RSTA Assigned R2I Rep, for the corresponding ISTA. A combination of the values of the R2I NSTS and the R2I Rep does not lead to a total number of LTF that exceeds the RSTA Assigned R2I LTF Total for each corresponding ISTA.

Unfortunately, due to additional receive processing for 320 MHz not all WiFi receivers can support same capabilities for 20-320 MHz and FIG. 4 does not define any capability bits for a maximum allowed number of repetitions or for a maximum allowed number of LTF (long training frame) totals for channel BWs above 160 MHz and up through 320 MHz.

Now discussed are additional capability bits added to a ranging subelement in a WiFi ranging frame for channel BWs above 160 MHz and up through 320 MHz. These additional capability bits increase the CSI (channel state information) size of maximum repetitions and maximum LTF totals up to 320 MHz, since they could be different than for 160 MHz or lower channel BWs.

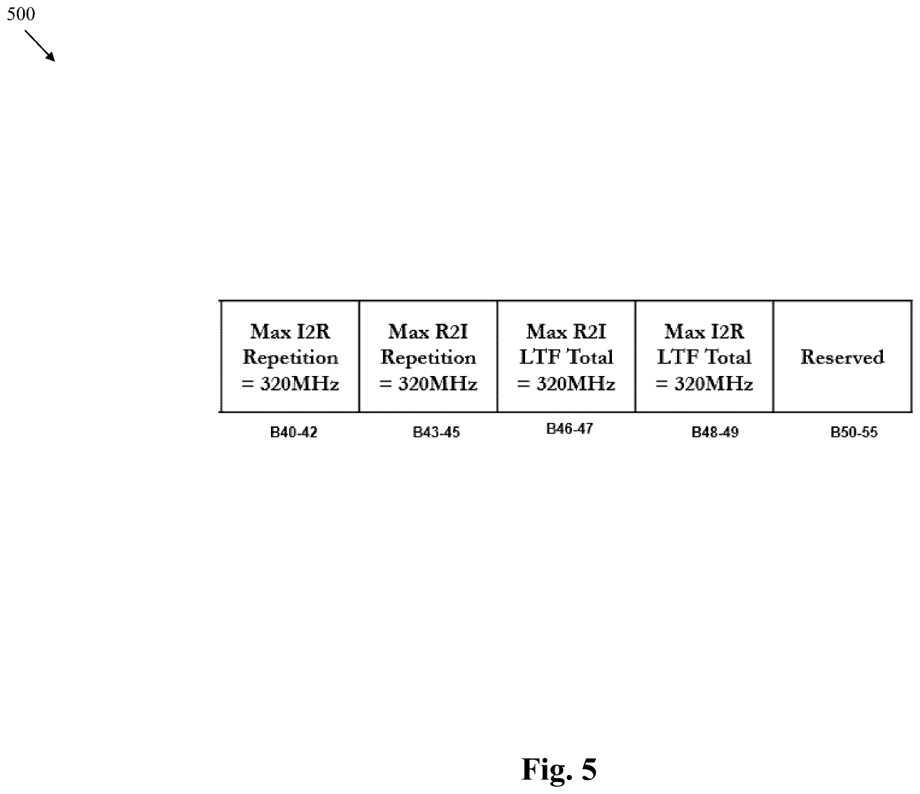

FIG. 5 represents an example 500 set of additional fields to be included in the ranging subelement in the WiFi ranging frame. These example additional fields 500 are also embedded within the messages (M1, M2) exchanged between the first and second wireless communication devices (STA, AP).

As shown in FIG. 5, the additional set of subelement fields includes:
a. a Max I2R Repetition=320 MHz subfield set to a maximum number of EHT-LTF repetitions that the ISTA uses in the preamble of 320 MHz I2R NDP (null data packet), and is set to a number of EHT-LTF repetitions minus 1;
b. a Max R2I Repetition=320 MHz subfield set to a maximum number of EHT-LTF repetitions that the ISTA uses in the preamble of 320 MHz I2R NDP (null data packet), and is set to the number of EHT-LTF repetitions minus 1;
c. a Max R2I LTF Total=320 MHz and Max I2R LTF Total=320 MHz subfields that respectively indicate a maximum number of EHT-LTFs to be destined to an ISTA in the 320 MHz R2I NDP (null data packet) and an RSTA in an 320 MHz I2R NDP. The maximum number of EHT-LTFs limits allowed combinations of number of space-time streams (Nss) and EHT-LTF repetitions.

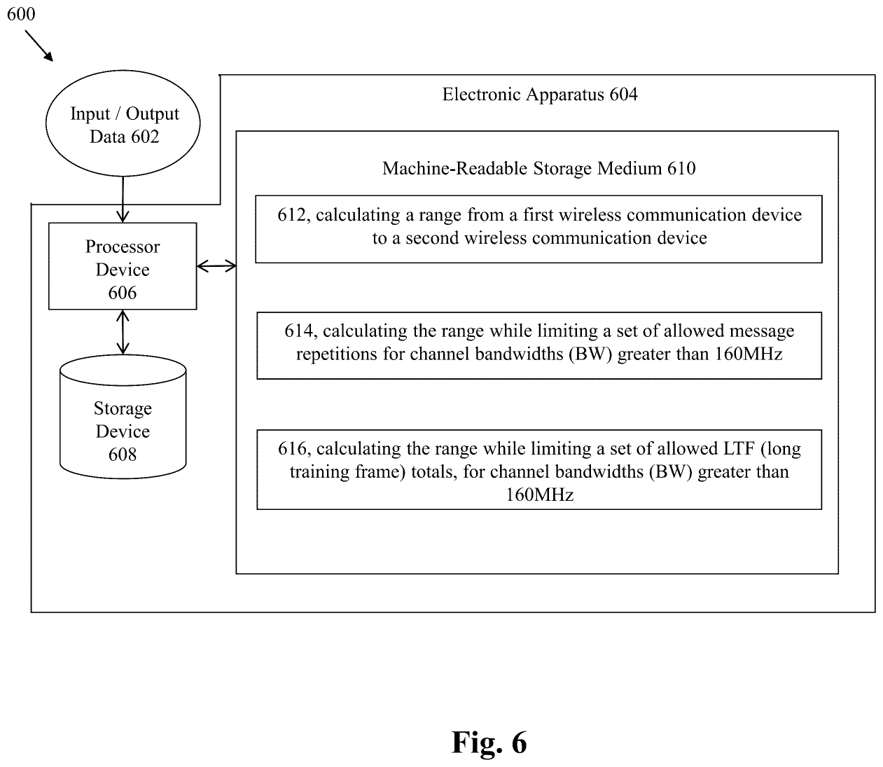

FIG. 6 represents an example system 600 for hosting instructions for enabling a WiFi ranging measurement apparatus. The system 600 shows an input/output data 602 interface with a computing device 604. The computing device 604 includes a processor device 606, a storage device 608, and a machine-readable storage medium 610. Instructions within the machine-readable storage medium 610 control how the processor 606 interprets and transforms the input data 602, using data within the storage device 608. The machine-readable storage medium in an alternate example embodiment is a computer-readable storage medium.

In one example, the instructions stored in the machine-readable storage medium 610 include: 612, calculating a range from a first wireless communication device to a second wireless communication device; 614, calculating the range while limiting a set of allowed message repetitions for channel bandwidths (BW) greater than 160 MHz; and 616, calculating the range while limiting a set of allowed LTF (long training frame) totals, for channel bandwidths (BW) greater than 160 MHz.

The instructions/steps in the above Figures can be executed in any order, unless explicitly limited to a specific order. The reference labeling order of the instructions/steps should not be interpreted as limiting the instructions/steps to that particular reference labeling order. Also, those skilled in the art will recognize that while one example set of instructions/method has been discussed, the material in this specification can be combined in a variety of ways to yield other examples as well, and are to be understood within a context provided by this detailed description.

In some example embodiments the set of instructions described above are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A first wireless communication device, comprising:
a transceiver configured to be coupled to an antenna;
a controller coupled to the transceiver;
wherein the controller is configured to calculate a range to a second wireless communication device based on a set of exchanged messages;
wherein the controller is configured to calculate the range while limiting at least one of: a set of allowed message repetitions and a set of allowed LTF (long training frame) totals, for channel bandwidths (BW) greater than 160 MHz.

2. The first device of claim 1:
wherein the channel bandwidth is less than or equal to 320 MHz.

3. The first device of claim 1:
wherein the controller is configured to calculate the range while limiting both the set of allowed message repetitions and the set of allowed LTF (long training frame) totals, for channel bandwidths (BW) greater than 160 MHz.

4. The first device of claim 1:
wherein the controller is configured to calculate the range using a time of flight (TOF) of a message transmitted from the first wireless communication device to the second wireless communication device.

5. The first device of claim 1:
wherein the controller is configured to calculate the range using a first time of flight (TOF) of a first message transmitted from the first wireless communication device to the second wireless communication device, and using a second time of flight (TOF) of a second message transmitted from the second wireless communication device to the first wireless communication device.

6. The first device of claim 1:
wherein the first device is a station (STA) and the second device is an access point (AP);
wherein the STA calculates its range to the AP as, range=c*TOF;
wherein c is a speed of light in a vacuum or air;
wherein TOF (Time Of Flight)=[(t4−t1)−(t3−t2)]/2;
wherein t1=TOD (Time Of Departure) of a first message (M1) transmitted from the STA to the AP;
wherein t2=TOA (Time OF Arrival) of the first message (M1) received by the AP;
wherein t3=TOD of a second message (M2) transmitted from the AP to the STA; and
wherein t4=TOA of the second message (M2) received by the STA.

7. The first device of claim 1:
wherein the calculate the range is non-trigger-based; and
wherein the set of messages exchanged between the first device and the second device include: a Measurement Sounding part, that performs two-way exchange of Null Data frames to acquire a channel impulse response; and a Reporting part, that exchanges encrypted TOF (Time Of Flight) estimations.

8. The first device of claim 1:
wherein the calculate the range is trigger-based;
wherein the first device is part of a set of devices assigned to the second device; and
wherein the set of messages exchanged between the first device and the second device include: a Polling part, that performs a fast poll among the set of assigned devices to identify short term resource needs; a Position (FTM) Sounding part, that performs a two-way exchange of Null Data frames to acquire a channel impulse response; and a Reporting part, that exchanges encrypted TOF (Time Of Flight) estimations.

9. The first device of claim 1:
wherein the set of messages include a format and bandwidth subfield that indicates a requested or allocated PPDU format and a bandwidth (BW) used to transmit the messages.

10. The first device of claim 9:
wherein the format and bandwidth subfield includes capability bits that specify support for 160 MHz operation and support for 320 MHz operation.

11. The first device of claim 1:
wherein the first device is an Initiating STA (ISTA) and the second device is a Responding STA (RSTA); and
wherein the range is an I2R/R2I (ISTA to RSTA/RSTA to ISTA) range.

12. The first device of claim 11:
wherein the set of messages include a format and bandwidth subfield that includes capability bits that specify,
a Max R2I STS (a maximum number of space-time streams (STS) to be used in R2I NDP in a session); and
a Max I2R STS (a maximum number of space-time streams to be used in I2R NDP in a session).

13. The first device of claim 12:
wherein the format and bandwidth subfield includes capability bits that specify a Max I2R LTF Total, a Max R2I LTF Total, a Max I2R Repetition, and a Max R2I Repetition for BW<=160 MHz.

14. The first device of claim 11:
wherein the set of messages include a subelement that includes a Max I2R Repetition=320 MHz subfield set to a maximum number of EHT-LTF repetitions that the ISTA uses in a preamble of 320 MHz I2R NDP.

15. The first device of claim 14:
wherein the Max I2R Repetition=320 MHz subfield is set to a number of EHT-LTF repetitions minus 1.

16. The first device of claim 11:
wherein the set of messages include a subelement that includes a Max R2I Repetition=320 MHz subfield set to a maximum number of EHT-LTF repetitions that the RSTA uses in the preamble of 320 MHz R2I NDP.

17. The first device of claim 16:
wherein the Max R2I Repetition=320 MHz subfield is set to a number of EHT-LTF repetitions minus 1.

18. The first device of claim 11:
wherein the set of messages include a subelement that includes a Max R2I LTF Total=320 MHz that indicates a maximum number of EHT-LTFs to be destined to an ISTA in the 320 MHz R2I NDP.

19. The first device of claim 11:
wherein the set of messages include a subelement that includes a Max I2R LTF Total=320 MHz subfields that indicates a maximum number of EHT-LTFs to be destined to an RSTA in an 320 MHz I2R NDP.

20. The first device of claim 11:
wherein the first and second messages advertise or list an I2R/R2I repetition capability for BW=320 MHz and BW<=160 MHz separately.

21. The first device of claim 11:
wherein first and second messages advertise or list an I2R/R2I LTF total capability for BW=320 MHz and BW<=160 MHz separately.

22. The first device of claim 1:
wherein the I2R/R2I repetition capability and the I2R/R2I LTF total capability are advertised or listed in a subelement of the messages.

23. The first device of claim 1:
wherein the first and second messages conform to wireless LAN medium access control (MAC) and physical layer (PHY) protocols for WiFi communications.

24. A method for wireless ranging, comprising:
calculating a range from a first wireless communication device to a second wireless communication device;
calculating the range while limiting a set of allowed message repetitions for channel bandwidths (BW) greater than 160 MHz; and
calculating the range while limiting a set of allowed LTF (long training frame) totals, for channel bandwidths (BW) greater than 160 MHz.
